(19) United States
(12) Patent Application Publication
(10) Pub. No.: US 2004/0154313 A1
(43) Pub. Date: Aug. 12, 2004

(54) Water cooler

(76) Inventors: Bruce Taylor, Goomiellabah (AU); Adam Shipway, Morningside (AU)

Correspondence Address: MCGUIREWOODS, LLP, 1750 TYSONS BLVD, SUITE 1800, MCLEAN, VA, 22102, US

(21) Appl. No.: 10/474,359

(22) PCT Filed: Mar. 28, 2002
(86) PCT No.: PCT/AU02/00414

(30) Foreign Application Priority Data
Apr. 9, 2001 (AU) PR 4298

(51) Int. Cl. F25B 21/02; B67D 5/62

(52) U.S. Cl. 62/3.64; 62/391; 62/397

(57) ABSTRACT

The present invention provides a water cooler assembly including a receptacle to hold water to be cooled and from which water can be dispensed; a cover attached to said receptacle via a hinge, said cover including formations to receive and hold a water bottle, and further including an inlet passage through which water from said bottle can flow into said receptacle; said cover having mountings to receive a cooling assembly, said cooling assembly being mounted in said cover close and extending away from said cover. The present invention also provides a water cooler assembly including a receptacle to hold water to be cooled and from which water can be dispensed, means to receive and hold a water bottle, and further including an inlet passage through which water from said bottle can flow into said receptacle; a cooling means associated with said receptacle to cool said water, and a trough attached to said inlet, from which trough water can enter said receptacle to be cooled. The trough can be arranged so that water which remains in said trough can be passed out of said assembly.

### FIELD OF THE INVENTION

The present invention relates to water coolers and improvements to water cooler construction.

### BACKGROUND OF THE INVENTION

Water cooler technology has been in the market place for some time. A small number of water coolers utilise thermo-electrical materials to provide the cooling system in order to keep noise and the costs of refrigeration down. Such cooling systems generally work on the basis of forming an ice mass which is utilised to keep the water cool.

In commercial applications such as offices etc water coolers have been popular for many years particularly where water supply is either not reliable or not of sufficient quality to offer to staff and clients. However, due to variability in domestic water quality, bottled water is expanding into the domestic market. Water coolers for the commercial market are not readily accepted in the domestic market due to size of the unit and the space it occupies. Further, when commercial units are down sized for domestic use icing of the water supply can occur such that users may not be able to extract water from their water cooler.

### SUMMARY OF THE INVENTION

The present invention provides a water cooler assembly, said assembly including:

a receptacle to hold water to be cooled and from which water can be dispensed;

a cover attached to said receptacle via a hinge, said cover including formations to receive and hold a water bottle, and further including an inlet passage through which water from said bottle can flow into said receptacle;

said cover having mountings to receive a cooling assembly,

said cooling assembly being mounted in said cover close and extending away from said cover.

The arrangement above is such that when in use any ice formation formed on said cooling assembly will drip back into said receptacle when said cover is rotated to an open position away from said receptacle. Preferably the rotation of the cover is limited.

The cover can be hollow, at least in part.

The receptacle is preferably of a unitary construction whereby the portion which holds water has no seams or joins. The receptacle preferably includes front, rear and side walls which angle outwardly from the centre of the receptacle, whereby any ice formation that forms and which extends to the side walls can still be rotated out of the receptacle when the cover is rotated to said open position.

The hinge between the cover and the receptacle is preferably hollow and allows the air fanned away from said cooling assembly to pass out of said cover and into a cavity at the rear of said receptacle.

The water cooler assembly can include a trough attached to said inlet, from which trough water can enter said receptacle to be cooled. Also the trough can be arranged so that water which remains in said trough can be passed out of said assembly.

The assembly can include a tap means associated with said trough. The tap means and said trough can be positioned in said assembly to be adjacent each other. The tap assembly can include a shaped end which allows the trough to be rotated away from the tap assembly without said shaped end interfering with an arcuate path of said trough or a portion of said trough out of the receptacle.

A funnel formation can be present in said cover through which said inlet passage is formed. The funnel can include a hollow spike formation, formed integral therewith, or assembled thereto, which will pierce a sealed covering over the rim of said bottle, when the sealed bottle is first inserted into the water cooler. The contents of the bottle will pass out of rim of the bottle through said hollow spike formation and proceed into said trough. Preferably said funnel includes at least one drainage aperture which opens out in the direction of said hinge. The drainage aperture serving the function of emptying the funnel of any water back to the receptacle as the cover is rotated away from the receptacle, or once the cover is rotated to the open position.

Preferably the funnel means includes a portion which passes through a hollow part of said cover. Preferably part of said funnel means can be heated by air drawn into said hollow.

Preferably said inlet and said cooling member being located side by side so that water entering said receptacle via said inlet will pass close to said cooling member.

Preferably, when said cover is in a closed position a cooling element which contacts the contents of the receptacle is extending downwardly away from the cover.

The system can include a trough formation to receive water from said inlet. Water can thus enter said receptacle from said trough formation. The trough formation can additionally contain water to pass water to one of said at least one outlets. Preferably there are two outlets, one outlet to pass out cooled water and another outlet passes out water which is substantially sourced from said trough.

The water entering the receptacle via said trough, does so by flowing over a wall of said trough.

The cooling assembly is of the thermoelectric type and is positioned so as to extend downwardly.

A fan in association with said cooling assembly to draw air from a hot side of said cooling assembly.

Control and/or transformer means for said cooling assembly are preferably mounted at an end of said receptacle opposite said at least one outlet.

The fan preferably blows air from said cooling assembly, through the hollow hinge member and over and/or around said control and/or transformer means. The air also can pass by the rear wall of said receptacle thereby heating said rear wall.

Preferably the cover includes a barrier means to prevent a predetermined amount of water from entering into the space occupied by said control and/or transformer means.

The present invention also provides a water cooler assembly including a receptacle to hold water to be cooled and from which water can be dispensed, means to receive and hold a water bottle, and further including an inlet passage through which water from said bottle can flow into said receptacle; a cooling means associated with said receptacle to cool said water, and a trough attached to said inlet, from which trough water can enter said receptacle to be cooled. The trough can be arranged so that water which remains in said trough can be passed out of said assembly.

### BRIEF DESCRIPTION OF THE DRAWINGS

Embodiments of the present invention, will be described by way of example only, with reference to the accompanying drawings, in which:

FIG. 1 illustrates a rendered perspective view of a water cooler;

FIG. 2 illustrates the major moulded components of the water cooler of FIG. 1 in an exploded perspective view;

FIG. 3 illustrates a plan view of the apparatus of FIG. 1;

FIG. 4 illustrates a cross section through the line BB of FIG. 3;

FIG. 5 illustrates a cross section through the line CC of FIG. 3;

FIG. 6 illustrates a cross section through the line DD of FIG. 3;

FIG. 7 illustrates a cross section through the line EE of FIG. 3;

FIG. 8 illustrates a detail of a portion of FIG. 5;

FIG. 9 illustrates a detail of a portion of FIG. 7;

FIG. 10 illustrates a perspective view of the top cover upper moulding;

FIG. 11 illustrate a perspective view from the rear of the apparatus of FIG. 10;

FIG. 12 illustrates a perspective view from the front of the apparatus of FIG. 10;

FIG. 13 illustrates a perspective view of the top cover lower moulding;

FIG. 14 illustrates a perspective view from the rear of the moulding of FIG. 13;

FIG. 15 illustrates an underneath perspective view from the rear of the moulding of FIG. 13;

FIG. 16 illustrates the bucket inner in perspective view from the rear;

FIG. 17 illustrates the bucket inner moulding of FIG. 16 in an underneath view from the front;

FIG. 18 illustrates the moulding of FIG. 16 in a perspective view from the rear;

FIG. 19 illustrates a perspective view of a trough;

FIG. 20 illustrates a rear perspective view of the trough of FIG. 19;

FIG. 21 illustrates a front elevation of an axle member;

FIG. 22 illustrates a plan view of the apparatus of FIG. 21;

FIG. 23 illustrates a rear view of the apparatus of FIG. 21;

FIG. 24 illustrates a perspective view of a hollow spike; and

FIG. 25 illustrates a perspective view of a water cooler similar to that of FIG. 1 with a modified vent cover.

### DETAILED DESCRIPTION OF THE EMBODIMENTS

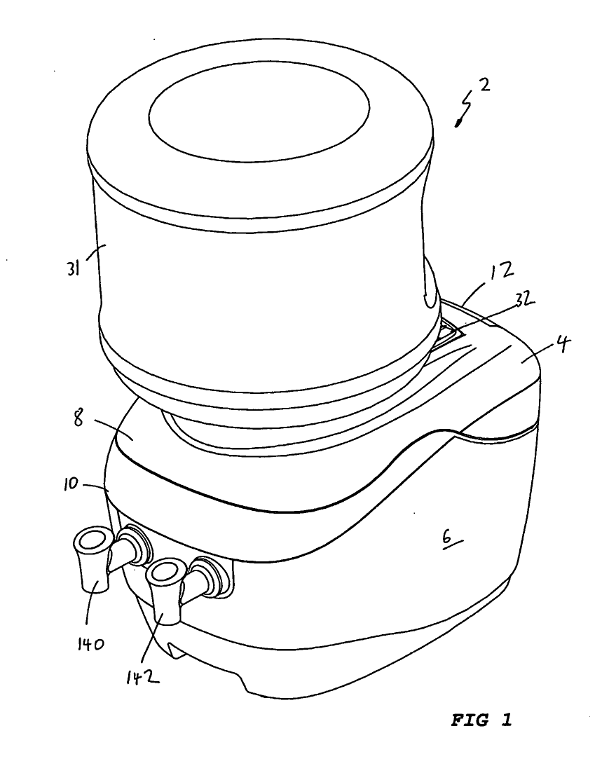

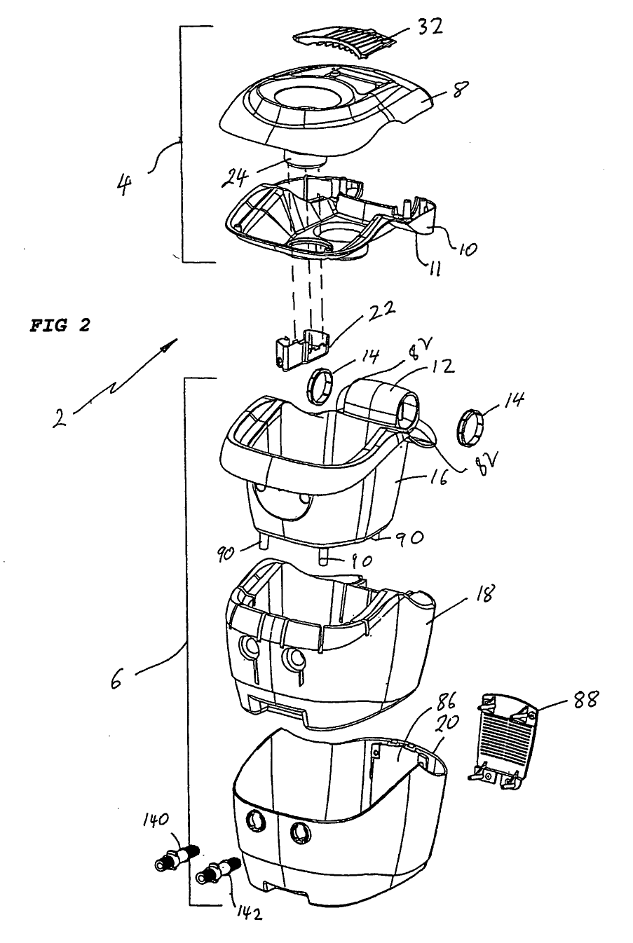

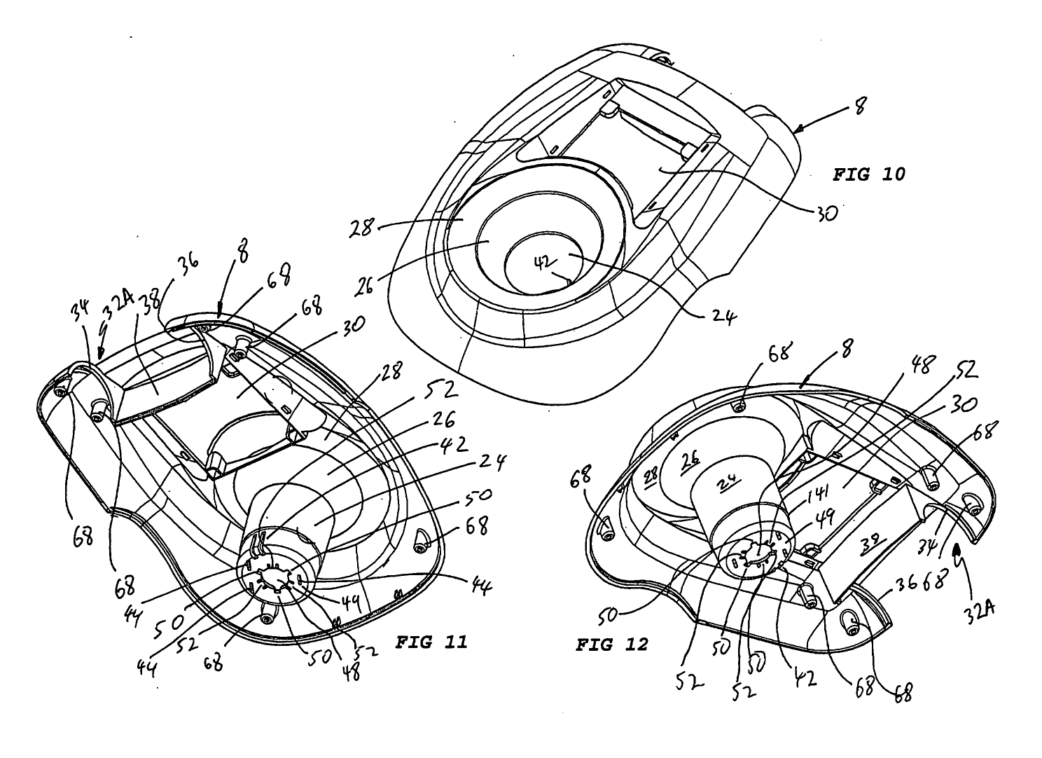

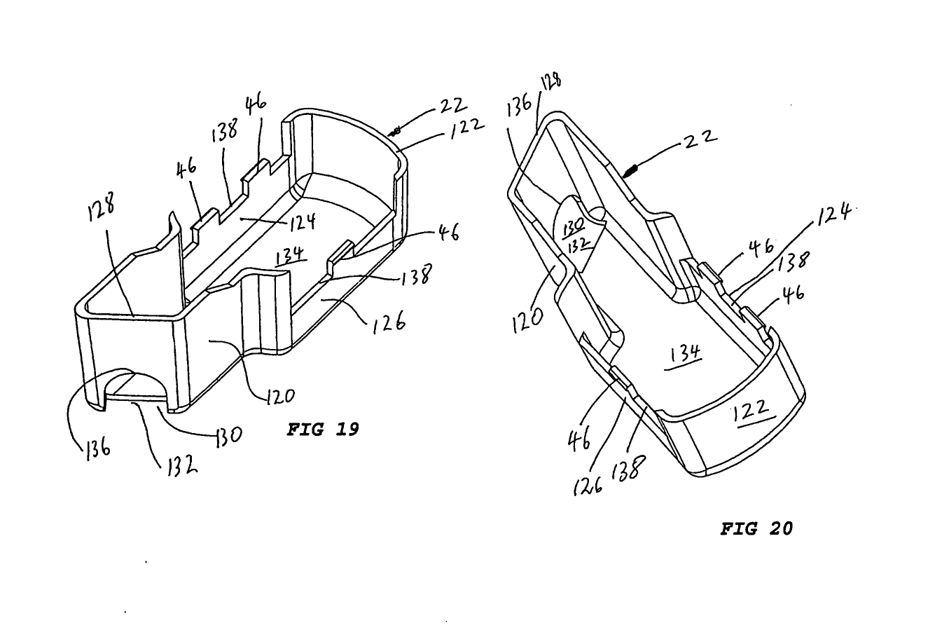

Illustrated in FIGS. 1 and 2 is a water cooler 2 which has a cover assembly 4 and a receptacle assembly 6. The cover assembly 4 is of a hollow construction and as illustrated in FIG. 2 is made up of an upper member 8 and a lower member 10 which will be discussed in more detail with reference to FIGS. 10 to 15. The cover assembly 4 has a downwardly extending funnel 24 to which is connected a trough member 22. The cover assembly 4 hingedly connects, by means of a hollow hinge 12, to the receptacle assembly 6. This will be described in more detail with reference to FIGS. 19 and 20.

The receptacle assembly 6 is constructed from an inner bucket 16 having a shape which will be received by an insulation member 18. The front, rear and side walls of the bucket 16 all angle outwardly from the centre of the bucket, to give the bucket 16 an outwardly tapering appearance in a bottom to top direction. The insulation member 18 has its internal surfaces shaped so that the bucket 16 will fit snugly into the insulation member 18 in order to maximise the insulative interaction between the two components. The insulation member 18 is received by receptacle outer portion 20.

From FIGS. 17 and 18 it can be seen that the lower portion of the bucket 16 has screw receiving spigots 90 which will allow the receptacle outer portion 20 to be secured to the bucket 16 thus sandwiching the insulating member 18 therebetween.

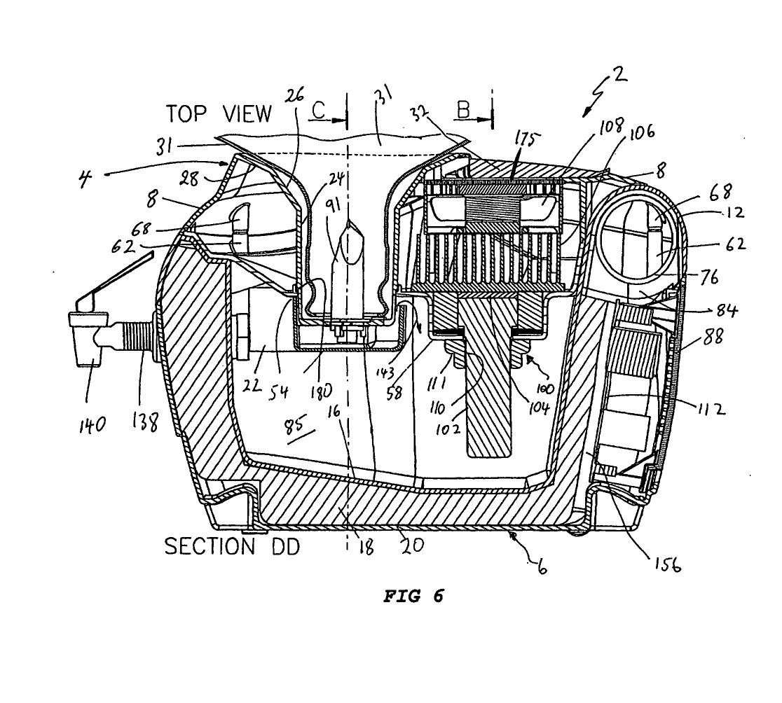

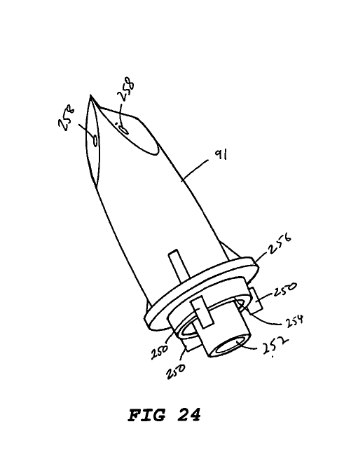

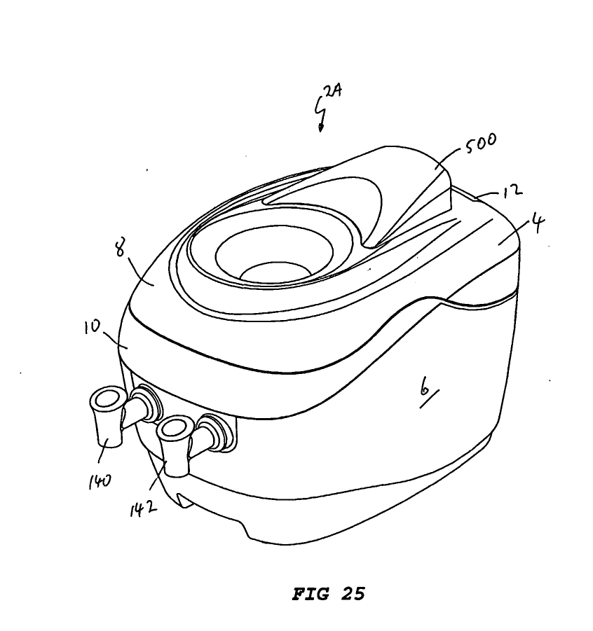

As illustrated in FIGS. 10 to 12 the moulding of the upper member 8 has a funnel 24 which extends downwardly from the lower end of a frusto-conical surface 26. Adjacent the upper rim of frusto-conical surface 26 is another frusto-conical surface 28. The frusto-conical surface 28, and if needed the surface 26, as illustrated in FIG. 24 serve as a seat on which to support a water bottle 31 as illustrated in FIG. 6.

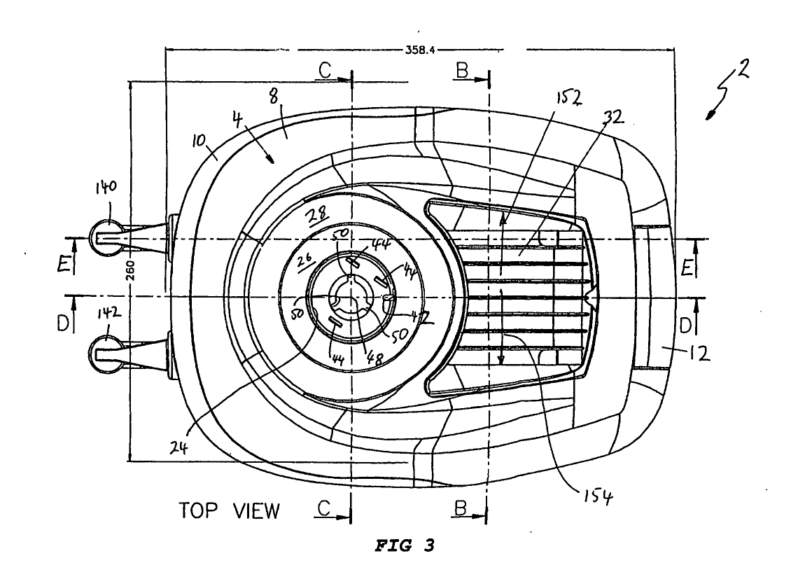

The frusto-conical surfaces 26 and 28 and the funnel 24 all lie in a forward portion on the upper member 8 and cover assembly 4. Adjacent these surfaces 26 and 28 is an access aperture 30, which when the assembly is finalised, will be covered by a vent 32 (see FIGS. 2 and 3).

Adjacent the aperture 30 at the rear of the upper member 8 is an upper half hinge assembly 32A for the cover assembly 4. The upper half hinge assembly 32A consists of semi-circular flanges 34 and 36 which are interconnected by a wall portion 38

The funnel 24 has a rearwardly directed opening 42 which allows drainage of any water gathered inside the funnel 24 to flow in a rearward direction. The opening 42 assists in the drainage of water out of the funnel in the case where the cover assembly 4 is rotated away from the receptacle assembly 6. Water will not ordinarily be present in the funnel 24 due to the seal on the bottle generally sealing with a hollow spike member 1 (see FIG. 6). The funnel 24 also includes three slots 44 which receive mating tabs 46 on the trough member 22, which is illustrated in more detail in FIGS. 19 and 20.

In the centre of the funnel 24 is an aperture 48 which has three equi spaced cut outs 50 through which tabs 250 on a hollow spike member 91 (see FIG. 24) can pass. Projections 52 are formed on the lower surface 49 of the funnel 24 so that the spike member 91 (see FIG. 24) can have its tabs 250 resting between the projections 52 to thereby hold the spike member 91 in position.

The hollow spike 91 as illustrated is FIG. 24 is of a tubular construction, having two concentric tubes 252 and 254. A flange 256 co-operates with the tab 250 to secure the spike 91 in the aperture 48 in the base of funnel 24. The tube 252 carries water in the bottle 31 from the top of the spike 91 and passes it into the trough 22. The annular space between tube 254 and tube 252 carries air back into the water bottle which exits the spike 91 via outlets 258.

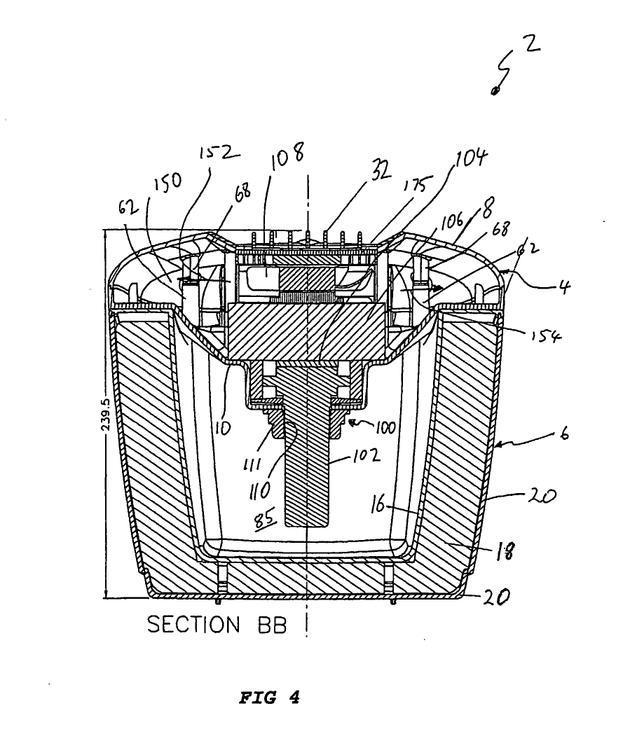

Illustrated in FIGS. 13 to 15 is the cover lower portion 10 which is a plastic moulding having an aperture 54 which is sized so as to receive the funnel 24. To the rear of the aperture 54 is a cavity 56 having a flange 58 and an aperture 60 therein. The cavity 56 receives a cooling assembly 100 (see FIGS. 4 to 7) to be used by the water cooler 2. The flange 58 is sandwiched by the cooling assembly 100 so as to hold the cooling assembly 100 in place relative to the lower member 10.

To the rear of the cavity 56 is a lower half hinge assembly 32B which includes semi-circular flanges 64 and 66 which are interconnected by wall portion 40. The flanges 64 and 66 co-operate with the upper semi-circular flanges 34 and 36 respectively on the upper hinge assembly 32A to form a circular flange when the upper member 8 is secured to the lower member 10.

The upper member 8 and lower member 10 are secured together by screws which are passed into cavities 70 and held by and extend through hollow screw receiving columns 62 on the cover lower portion 10 to engage screw receiving blocks 68 on the upper member 8.

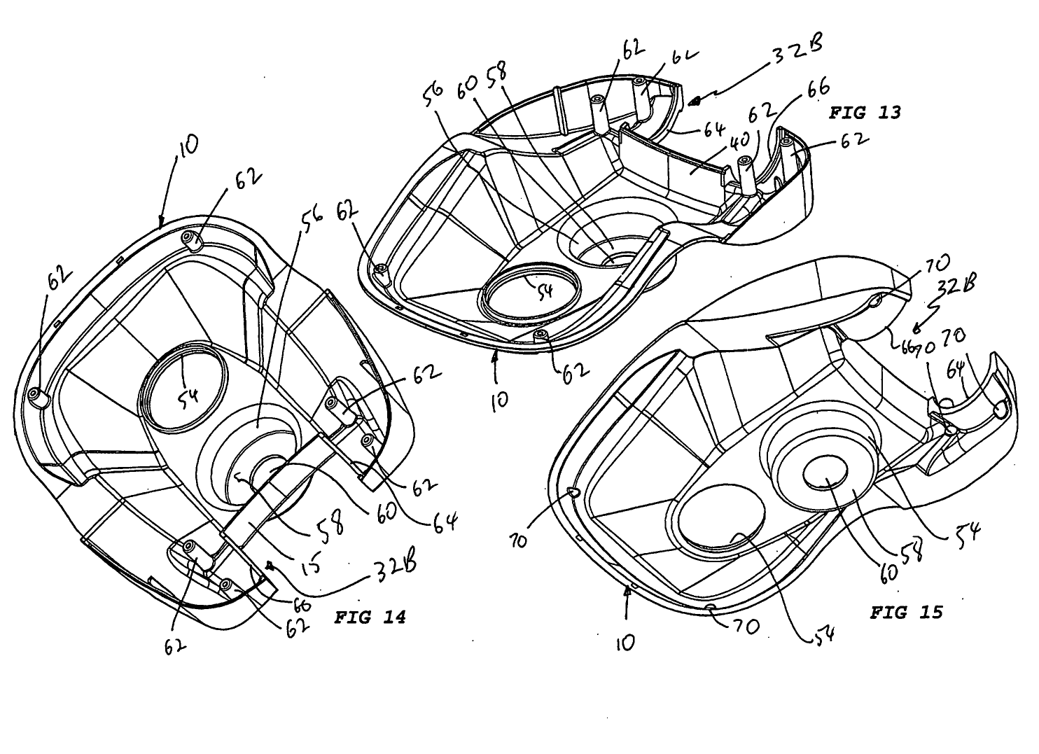

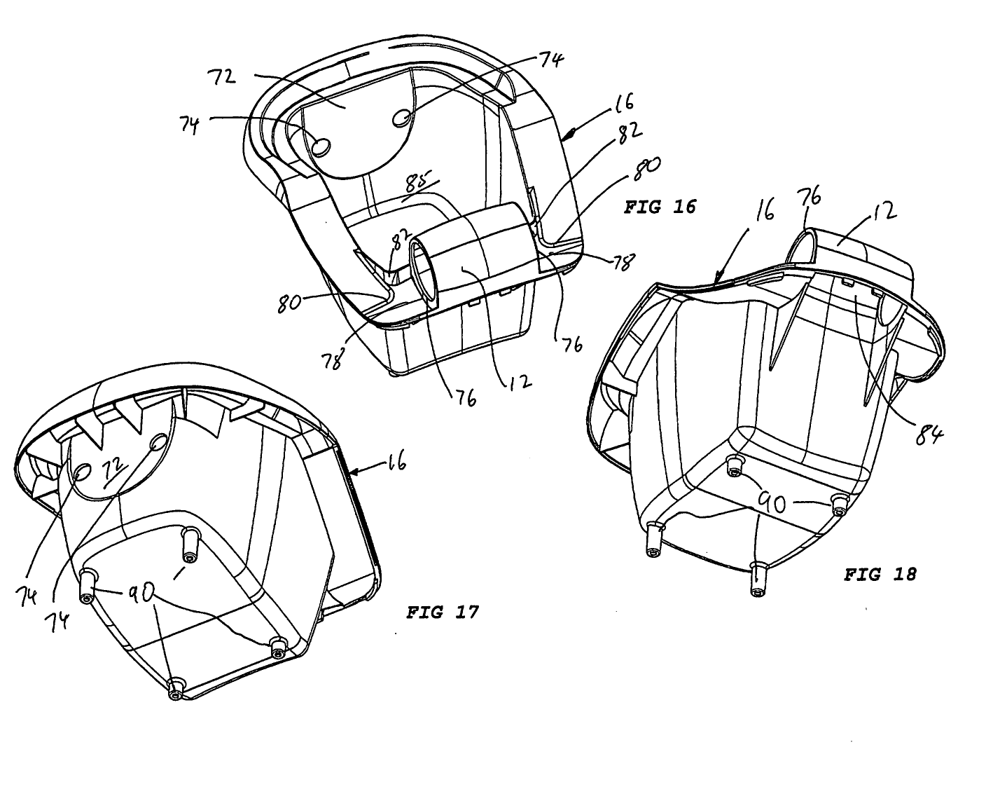

Illustrated in FIGS. 16 to 18 is the bucket 16. Inner bucket 16 has a forward portion 72 having two outlet holes 74 through which taps 140 and 142 (see FIGS. 1 to 3) can be inserted. The taps 140 and 142 have communicable passage to different parts of the internal portions of the bucket 16, as will be discussed below.

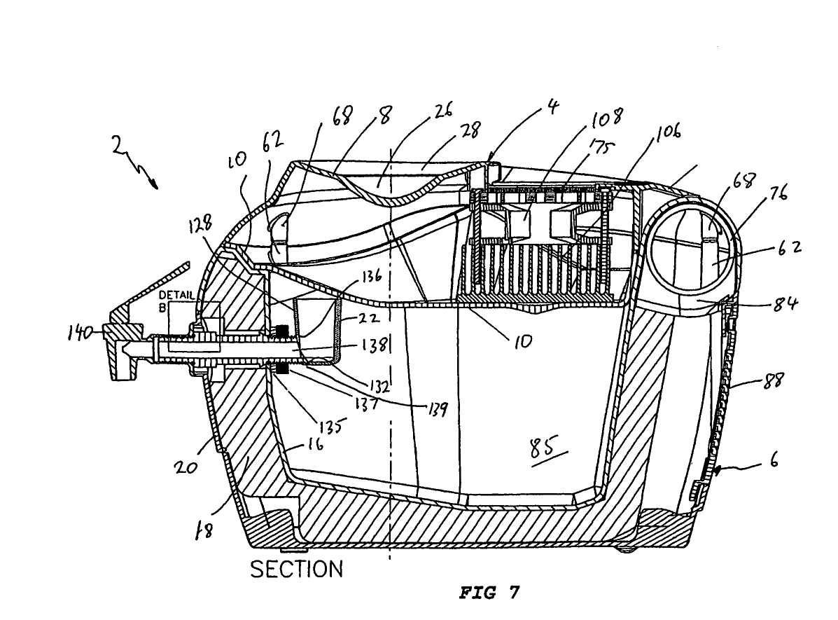

As the bucket 16 is made from a single moulding, the water holding portion 85 below the apertures 74 has no seals, joins or seams thus making water holding portion 85 permanently water tight. A seal member 135 (see FIG. 7) is compressed by a nut 137 to secure and seal the taps 140 and 142 to the receptacle assembly 6. The seal members 135 allow the water level in the receptacle assembly 6 to rise above the aperture 74.

At the rear of the bucket 16 is the hollow hinge member 12 which has a circular flange 76 on the left and right hand side thereof. The flanges 76 have the same internal diameter as the circular flange formed by hinge assemblies 32A and 32B on the cover assembly 4 when that sub-assembly is assembled.

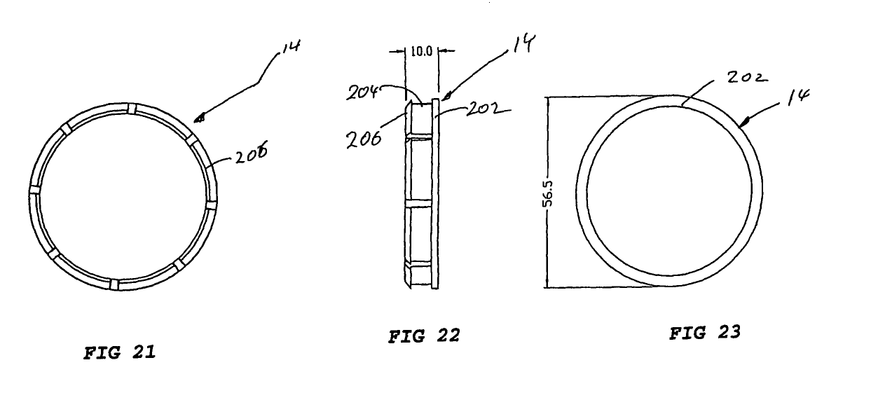

To assemble the cover assembly 4 to the receptacle assembly 6, a hinge axle 14 (see FIG. 2) is utilised and is illustrated in more detail in FIGS. 21, 22 and 23.

The hinge axle 14 has a flange portion 202 with equi-spaced segments 204 which terminate with a lip 206. The distance between the lip 206 to the flange 202 is such that the width of the flange 76 and the width of the flanges 34 and 64, or 26 and 66 will fit snugly therein yet allow rotation of the cover assembly 4 relative to the hollow hinge 12.

To assemble the cover assembly 4 to the receptacle assembly 6 the cover assembly 4 is positioned adjacent to the receptacle assembly 6 so that the circular hinge formation formed by the upper and lower hinge assemblies 32A and 32B are aligned with the flange 76 on the hollow hinge 12. Once aligned an assembler can push the hinge axle 14 through aperture 84 and outwardly through the hinge flange 76 so as to engage the circular hinge formation formed by the upper and lower hinge assemblies 32A and 32B.

The flanges 76 act as a dam or barrier to water entering into the hollow hinge 12 should any water gather in the regions 78 on the upper lip of the bucket 16. To further assist in preventing water gathering in the region of the hinge 12 and its flange portions 76 a channel 80 is provided on each side to direct water away therefrom. To also prevent water exiting the bucket 16 and going into the hinge 12, a wall member 82 is provided which extends from the hinge 12 around the rear of the upper rim of the bucket 16 to form generally an L-shaped barrier.

As can be seen in FIG. 18 the hollow hinge 12 has three apertures associated with it. The first two apertures are defined by the internal diameter of the flanges 76 and a third aperture 84 is located underneath the hinge 12 as illustrated in FIG. 18. The third aperture 84 is a downwardly directed opening whereby air passing through the flanges 76 will be directed in a downward direction via aperture 84. From the aperture 84 as can be seen from FIG. 2 air will pass out of the receptacle outer portion 20 by means of the aperture 86, which in use, will be covered by a rear vent panel 88.

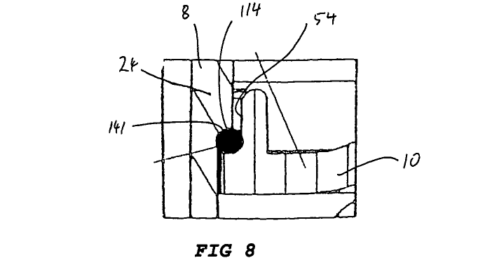

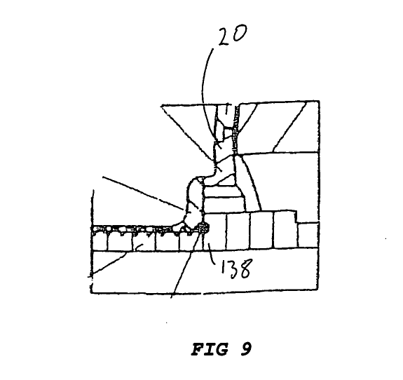

In assembling all the components reference is now made to FIGS. 3 to 9 of the drawings.

The assembly of components is illustrated in FIG. 6, which is a cross section through the lines DD of FIG. 3. A cooling assembly 100 (being a proprietary component manufactured by Coolworks Inc of San Rafael, Calif.) consists of a probe 102 above which is a thermoelectric material 104, a heat sink 106 and a fan 108. The cooling assembly 100 and its functioning is substantially as described in U.S. Pat. No. 5,544,589 which is incorporated herein by reference.

An intermediate portion of the cooling probe 102 is threaded at 110 and this allows the whole cooling assembly to be attached to the flange 58 at the lower portion of cavity 56 by clamping the flange 58 with nut 111. Once secured to the lower member 10, the wires of the cooling assembly are passed to the rear of the cover assembly 4 and through the flanges 76, then down through aperture 84 to a printed circuit board 112 which carries the water cooler controls and or the transformer.

When the upper member 8 and lower member 10 are assembled the funnel 24 protrudes through the aperture 54 and as can be seen from FIG. 8 the outside of aperture 54 has a flange to receive an O-ring 114 to seal the aperture 54 to the outer surface of the funnel 24. By this means water cannot enter the hollow of cover assembly 4 through aperture 54.

To the base of the funnel 24 is attached the trough member 22. The trough member 22 as illustrated in FIGS. 19 and 20 has a forward wall portion 120 and a rearward wall portion 122 which are interconnected by wall portions 124 and 126. The wall portions 124 and 126 respectively carry the tabs 46 for engaging the trough 22 to the funnel 24. The wall portion 120 is of a height which is greater than the wall portion 122 and both wall portions 120 and 122 are of a height greater than the wall portions 124 and 126. The forward wall portion 120 has an angled front face 128 in which is located an exit port 130. The exit port 130 is bordered at its lower end by an edge 132 at a forward periphery of the floor 134 of the trough 22. When the trough 22 is positioned on the funnel 24, as illustrated in the cross section of FIG. 7, the edge 132 will rest near to the rearmost lowermost edge 139 of the tap tube 138 of the tap 140. The rear end of the tap tube 138 will sit within the port 130; and while not being sealed thereto will ensure water in the trough 22 will flow out of the top tube 138 when top 140 is open.

Any water in the trough 22 will flow out therefrom via the tap 140 when the tap 140 is open.

A second tap 142 is provided which has direct access to the cooled water (when cooling assembly 100 is functioning) contained in the water holding portion 85 of the receptacle 16.

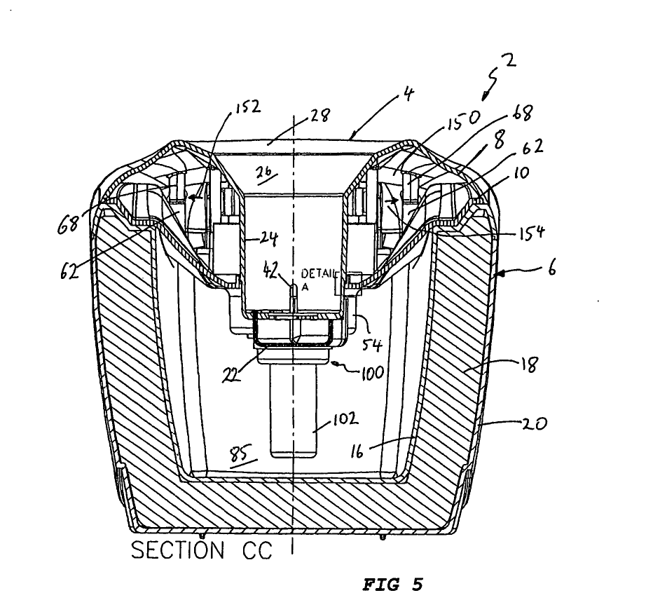

In use, water will pass out of the bottle 31 through the hollow spike 91 in the funnel 24 and will overfill the trough 22 whereby water will, in the main, pass out of the trough 22 by passing over the rear wall 122. This will transfer water into the water holding portion 85 of the receptacle until the water level reaches the rim 93 (see FIG. 24) of the water bottle neck which is designed to be located at or just above sealing flange 141 on the funnel 24 (as visible in FIGS. 11, 12, 8, 5 and 6).

Once water is extracted via tap 142, that is from the cooled water contained in the water holding portion 85, the water will be replaced by water exiting the water bottle 31 and flowing in the direction of arrow 143 (see FIG. 6).

In use the probe 102 will have an ice formation (generally in a shape similar to a ball) formed thereon due to the thermoelectric heat extraction process. The relatively warm water entering the water holding portion 85 in the direction of arrow 143 from over the rear wall 122 of trough 222 will tend to flow around the ice formation and thus cooled.

Another feature of the water cooler 2 is that the tap 142 is located at the opposite end of the water cooler receptacle assembly 6 to the location of the cooling assembly 100 and probe 102. This feature ensures that the water around the taps 140 and 142 will not freeze.

As can be seen from the cross sections of FIGS. 5, 6, 7 and 8 the cover assembly 4 has, between the upper member 8 and lower member 18, a cavity 150 which surrounds the funnel 24. Cavity 150 includes space for the cooling assembly 100 and the fan 108 will draw air into the cover assembly 4 via vent 32 and an associated filter element 175, which air must pass through the heat sink 106.

From the heat sink 106 the air moves into and out of the page of FIGS. 6 and 7 and in the directions of arrows 152 and 154 respectively to the left and right sides of the cavity 150 as illustrated. This heated air also fills the cavity 150 thereby heating the funnel 24. The only way in which the air can pass out of the cavity 150 is via the circular flange of the assembled upper and lower hinge assemblies 32A and 32B. The air then flows through flanges 76 on the hollow hinge 12 and exits the hollow hinge 12 via the aperture 84. The air then proceeds over the printed circuit board 112 and through the passage 156 to the rear thereof (the passage 156 being adjacent the rear portion of the insulator 18) whereupon the air will exit the rear of the receptacle assembly 6 via the vent 88.

Although insulation 18 does help to maintain water contained in the water holding portion 85 relatively cool, the action of passing the heated air along the rear wall of insulation 18 (the rear wall being the closest to the probe 102) means that the angled rear wall, (being closest to the ice ball which will form during operation), will transfer heat to the water. By having this heat source in this location helps to prevent the complete icing of the water contained within the water holding portion 84 by the probe 102. Additionally, it is thought that the heating of the funnel 24 assists in helping to prevent the complete icing of the water. At the least it is thought to inhibit the forward growth of the ice ball. It has been found in trials that even if there is no more water left in the water bottle 31, the unit will not freeze completely.

One of the advantages of construction of the water cooling unit 2 is that should it be necessary to clean the water holding portion 85 (which should be done every 3 to 6 months), the cover assembly 4 simply need be rotated out of its rest position which will lift the ice ball and the cooling assembly 100 out of the water holding portion By limiting the rotation of the cover assembly 4 relative to the receptacle assembly 6, which is done by the surfaces 11 (see FIGS. 2, 13 and 15) engaging the walls 82 (see FIGS. 2 and 16) to between 95 degrees and 120 degrees; the ice ball will melt and will drip back into the water receptacle and if any water should fall on the top lip of the water receptacle this will be carried away to the left and right rear sides of the unit as described above.

Further to allow the rotation of the cover assembly 4 the tap tube 138 has a curved portion when viewed in side elevation or cross section of FIGS. 6 and 7 which will not impede the front edge 32 in its angular path out of the receptacle assembly 6 when the cover assembly 4 is rotated relative to the receptacle assembly 6.

A further advantage of mounting the cooling assembly 100 in a downward direction from the cover assembly 4 is that the overall height of the water cooler 2 with a standard 3 gallon (11 litre) water bottle 31 thereon will measure under 500 mm, making it able to be placed on kitchen counter tops and below overhead kitchen cupboards in kitchens in a majority of countries around the world.

Another advantage of the assembly described above is that the inlet vent 32 and associated filter element 175 through which cooling air will pass is located on the top of the water cooler 2. In this way, as dust accumulates on the inlet vent 32 and filter 175, as it will invariably do, the user can readily see and clean the vent and filter, without having to move the water cooler 2.

The spike 91 referred to above is preferred where the bottle 31 is sealed by a seal which requires piercing. In some countries, such as some of those of Europe, the bottles are sealed with a cap which has a pre-weakened portion and so a pointed or piercing spike 91 need not be utilised. Instead a simple tube arrangement could be used, where the tube pushes against the pre-weakened portion to gain access to the contents off the bottle. If the bottle were to be opened prior to insertion into the water cooler 2, then neither a spike 91 or an simple tube arrangement would be necessary.

The cover assembly 4 can include passages to direct the air from the fan 108 either directly to the hollow hinge 12 bypassing the cavity 150 of the cover assembly 4 in the region of the funnel 24, or to direct the air from the fan 108 into that cavity 150 for the purpose of flowing around the funnel 24. In this way a switch means can be provided whereby a summer/winter mode of operation is available. In summer mode, because ambient air may be quite warm, the funnel 24 will not require heating by the air. Whereas in winter mode as the ambient air tends to be cooler, the air from the fan 108 can be directed to pass around the funnel 24, thereby helping to prevent icing.

While the above embodiment utilises a hollow cover assembly 4, a cover assembly which is not hollow can also be utilised.

The components of the water cooler, particularly those in contact with water, are preferably manufactured from a potable water grade plastic or ABS, or a clarified poly propylene.

Illustrated in FIG. 25 is a water cooler 2A, which is substantially the same as the water cooler 2, and like parts have been like numbered. The water cooler 2A differs from the water cooler 2 in that the vent 32 is replaced by a deflector or cooling 500. The cooling 500 is used to protect the fan 108 and associated electrical components, in the event that water may fall on the top areas of the water cooler 2A. The vent 32 of water cooler 2 would not prevent the ingress of spilt water.

The cooling 500 serves only a protection from spillage function when the fan 108 is operating in the direction described above with respect to the water cooler 2, that is, air is drawn from the top of the cooler 2A and out through the rear vent 88 of the cooler 2A.

However, when the fan 108 is made to operate in the reverse direction to that described above, that is air is drawn through the rear vent 88 of the water cooler 2A and out through the top, the cooling 500 will direct the now heated air towards the rear of the cooler 2A. This has the added advantage of preventing the heated air from warming the water in the bottle 31 sitting on top of the water cooler 2A, while also providing a protection from spillage function.The cooling 500 also serves to deflect noise caused by the fan and the movement of air, irrespective of the direction of flow of the air through the cooler 2A.

In the embodiment of FIG. 25, the internal volume of the cover assembly 4, around the funnel 24 can include insulation which is preferably a premoulded insulation member sized and shaped to fit into this internal volume.

In the water cooler 2 the vent 32 includes a filter 175 to keep dust out of the internal portions of the water cooler 2. In the embodiment of FIG. 25 because the air flow has changed direction, a filter is preferably provided on the rear vent 88 so as to serve this filtering function.

To the embodiments described above there can be added a summer/winter switch to the fan control so that with the switch in the summer position the fan is driven at its full speed by the motor. When the switch is in the winter position, the fan is driven at a reduced speed, which helps to prevent over icing.

Throughout the specification and claims reference is made to the word “water” and the expression “water cooler”. While the predominant use of the apparatus described above is to cool water for drinking, it will be understood that it can be used to cool other liquids for drinking purposes. As such the word “water”, as used alone or in the expression “water cooler” will be understood to include within its scope other drinking liquids, which may or may not have a water base.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

1. A water cooler assembly including:
a receptacle to hold water to be cooled and from which water can be dispensed;
a cover attached to said receptacle via a hinge, said cover including formations to receive and hold a water bottle, and further including an inlet passage through which water from said bottle can flow into said receptacle;
said cover having mountings to receive a cooling assembly, said cooling assembly being mounted in said cover close and extending away from said cover.

2. A water cooler as claimed in claim 1, wherein when in use any ice formation formed on said cooling assembly will drip back into said receptacle when said cover is rotated to an open position away from said receptacle.

3. A water cooler as claimed in claim 1 or 2, wherein extent of rotation of the cover is limited, preferably by a detent mechanism.

4. A water cooler as claimed in any one of the preceding claims, wherein said cover is hollow, at least in part.

5. A water cooler as claimed in any one of the preceding claims, wherein the receptacle is of a unitary construction whereby the portion which holds water has no seams or joins.

6. A water cooler as claimed in any one of the preceding claims, wherein the receptacle includes front, rear and side walls which angle outwardly from the centre of the receptacle, whereby any ice formation that forms and which extends to the side walls can still be rotated out of the receptacle when the cover is rotated to said open position.

7. A water cooler as claimed in any one of the preceding claims, wherein the hinge between the cover and the receptacle is hollow and allows the air fanned away from said cooling assembly to pass out of said cover and into a cavity in said receptacle.

8. A water cooler as claimed in any one of the preceding claims, wherein the water cooler further includes a trough attached to said inlet, from which trough water can enter said receptacle to be cooled.

9. A water cooler as claimed in claim 8, wherein said trough is arranged so that water which remains in said trough can be passed out of said water cooler.

10. A water cooler as claimed in any one of the preceding claims, wherein there is included a tap means associated with said trough.

11. A water cooler as claimed in claim 10, wherein the tap means and said trough are positioned in said cooler adjacent to each other.

12. A water cooler as claimed in claim 10 or 11, where said tap assembly can include a shaped end which allows the trough to be rotated away from the tap assembly without said shaped end interfering with an arcuate path of said trough or a portion of said trough out of the receptacle.

13. A water cooler as claimed in any one of the preceding claims, wherein a funnel formation is present in said cover through which said inlet passage is formed.

14. A water cooler as claimed in claim 13, wherein said funnel includes a hollow spike formation, formed integral therewith, or assembled thereto, which will pierce a sealed covering over the rim of said bottle, when the sealed bottle is first inserted into the water cooler.

15. A water cooler as claimed in claim 14, wherein the contents of the bottle when in use, will pass out of a rim of the bottle through said hollow spike formation and proceed into said trough.

16. A water cooler as claimed in any one of claims 13 to 15, wherein said funnel includes at least one drainage aperture which opens out in the direction of said hinge.

17. A water cooler as claimed in any one of claims 13 to 16, wherein said funnel means includes a portion which passes through a hollow part of said cover.

18. A water cooler as claimed in any one of claims 13 to 17, wherein part of said funnel means is heated by air drawn into said hollow after cooling a source of heat associated with said cooling assembly.

19. A water cooler as claimed in any one of the preceding claims, wherein said inlet and said cooling member are located side by side so that water entering said receptacle via said inlet will pass close to said cooling member.

20. A water cooler as claimed in any one of the preceding claims, wherein when said cover is in a closed position a cooling element which contacts the contents of the receptacle is extending downwardly away from the cover.

21. A water cooler as claimed in any one of the preceding claims, wherein there are two outlets, one outlet to pass out cooled water and another outlet passes out water which is substantially sourced from said trough.

22. A water cooler as claimed in any one of claims 8 to 22, wherein water entering the receptacle via said trough, does so by flowing over a wall of said trough.

23. A water cooler as claimed in any one of the preceding claims, wherein said cooling assembly is of the thermo-electric type and is positioned to extend downwardly.

24. A water cooler as claimed in any one of the preceding claims, wherein a fan in association with said cooling assembly draws air from a hot region of said cooling assembly.

25. A water cooler as claimed in any one of the preceding claims, wherein control and or transformer means for said cooling assembly are preferably mounted at an end of said receptacle opposite said at least one outlet.

26. A water cooler as claimed in any one of the preceding claims, wherein the fan preferably blows air from said cooling assembly, through the hollow hinge member and over and or around said control and/or transformer means.

27. A water cooler as claimed in any one of claims 24 to 26, wherein the air blown by said fan also can pass by the rear wall of said receptacle thereby heating said rear wall.

29. A water cooler as claimed in any one of the preceding claims, wherein the cover includes a barrier means to act as a dam against water entering into the space occupied by said control and or transformer means.

30. A water cooler as claimed in any one of the preceding claims wherein there is provided at least two paths for air from the fan of said cooling assembly to travel out of said water cooler.

31. A water cooler as claimed in claim 30, wherein a first path directs said air out of said cover assembly where by no heating of said funnel will occur.

32. A water cooler as claimed in claim 30 or 31, wherein a second path directs said air out of said cover assembly after heating said funnel.

33. A water cooler as claimed in any one of claims 30 to 32 wherein a switch means is able to direct air as follows: along a first of said paths; along a second of said paths; equally along both of said paths simultaneously; along both simultaneously with ability to adjust the flow rate in respective paths.
